(19) United States
(12) Patent Application Publication
(10) Pub. No.: US 2003/0101096 A1
(43) Pub. Date: May 29, 2003

(54) Electronic account settlement system and method

(75) Inventors: Kazuyoshi Suzuki, Tokyo (JP); Keiichiro Inaba, Tokyo (JP); Tetsuya Maruoka, Kawasaki (JP); Shinobu Ito, Kawasaki (JP); Hiroshi Takahashi, Yokohama (JP)

Correspondence Address: Steve Y. Cho, Townsend and Townsend and Crew LLP, 8th Floor, Two Embarcadero Center, San Francisco, CA, 94111, US

(73) Assignee: Hitachi, Inc., Tokyo (JP)

(21) Appl. No.: 10/301,543

(22) Filed: Nov. 20, 2002

(30) Foreign Application Priority Data
Nov. 27, 2001 (JP) 2001-361295

(51) Int. Cl. G06F 17/60

(52) U.S. Cl. 705/17

(57) ABSTRACT

An electronic account settlement system includes a preauthorization device provided at a vendor site and having a first receiver to receive first identification information of a user. The preauthorization device is configured to initiate a preauthorization request for a subsequent transaction of a product or service between the user and a vendor of the vendor site. An accounting system is provided at a remote location from the preauthorization device. The accounting system has a database including account information relating to a plurality of users and is configured to receive the preauthorization request and decide whether to grant or reject the preauthorization request using the account information.

### CROSS-REFERENCES TO RELATED APPLICATIONS

The present application is related to and claims priority from Japanese Patent Application No. 2001-361295, filed on Nov. 27, 2001.

### BACKGROUND OF THE INVENTION

The present invention relates to an electronic account settlement system, an information processing system, an electronic account settlement method, and a program for electronic account settlement.

In recent years, a debit card used for cashless account settlement has been becoming popular. To be more specific, the debit card has the following advantages: it can be utilized as a credit card; and settlement for a purchase can be completed on the spot. The debit card will be explained in more detail below. In a store where a debit card can be used, a debit card terminal is installed. For example, when a user wishes to purchase a commodity in the store, the user inserts the debit card in the terminal and inputs a predetermined ID number (or password), so that the debit card terminal transmit requisite information to an outside accounting system using a communication medium. In this case, authentication procedure is performed to check whether or not the entered password is correct. Additionally, if the balance in a user's account is greater than or equal to the charged amount, the settlement is approved. Then, the charged amount is automatically debited from the balance of the savings account of the user.

Additionally, as a cashless settlement method, which does not require user's input of a password, there is, for example, a technique described in Japanese Patent Application Laid-Open No. 2001-22839. The electronic account settlement system and the electronic account settlement method, which are described in the document, are so devised that an upper limit of settlement amount is provided beforehand on the host side for each target item which a user purchases, and if the amount of purchase is smaller than or equal to the upper limit of settlement amount, the settlement is allowed without inputting the password.

Returning to the first settlement method using the debit card, when a user wishes to purchase a commodity or receive a service, the user must input a password into a given terminal to make the payment. The debit card terminal is usually installed at a conspicuous place such as a store counter of a retail store. Therefore, when a user inputs a password at such a place, there is a possibility that the password might be seen by a third party.

Returning to the second settlement method described in Japanese Patent Application Laid-Open No. 2001-22839, an input of a password is not required. However, it is necessary to provide an allowable limit of cashless purchase beforehand for each item, which a user purchases, which requires a large data table for each user.

Moreover, in both of the above settlement methods, an inquiry about necessary information is sent to the outside accounting system (host) side at the check out register to settle the purchase amount. Since the requisite information needs to be transmitted to the host accounting system and an authorization has to be received, the settlement process may take few to dozens of seconds, which may cause a long line to form at the cash register.

### BRIEF SUMMARY OF THE INVENTION

In one embodiment, an electronic account settlement system includes a preauthorization device provided at a vendor site and having a first receiver to receive first identification information of a user. The preauthorization device is configured to initiate a preauthorization request for a subsequent transaction of a product or service between the user and a vendor of the vendor site. An accounting system is provided at a remote location from the preauthorization device. The accounting system has a database including account information relating to a plurality of users and is configured to receive the preauthorization request and decide whether to grant or reject the preauthorization request using the account information.

In another embodiment, an electronic accounting system includes a preauthorization device provided at close proximity of an entrance of a vendor site. The preauthorization device includes a first receiver to receive first identification information of a user to initiate a preauthorization request prior to purchase of a product from the vendor site. An accounting system is provided at a remote location from the preauthorization device. The accounting system includes a database having account information of a plurality of users and is configured to receive the preauthorization request and transmit a reply to the preauthorization request. An authorization device is provided at a checkout location of the vendor site. The authorization device includes a second receiver to receive second identification information from the user in order to pay for a product the user has selected for purchase from the vendor site. The second identification information corresponds to the first identification information.

In another embodiment, a method for making a settlement in an electronic accounting system having an account information database that includes account information of a plurality of user is disclosed. The method includes receiving at the accounting system a preauthorization request for a transaction to be conducted by a user, the preauthorization request being initiated by reading first identification information of the user from a settlement device of the user using an electronic reader that is associated with a vendor with whom the user wishes to conduct the transaction; and transmitting a reply to the preauthorization request from the accounting system to a visitor database associated with the vendor with whom the user wishes to conduct the transaction.

In yet another embodiment, a computer readable medium includes code for receiving at an accounting system a preauthorization request for a transaction to be conducted by a user, wherein the preauthorization request is initiated by reading first identification information of the user from a settlement device of the user using an electronic reader that is associated with a vendor with whom the user wishes to conduct the transaction; code for transmitting a reply to the preauthorization request from the accounting system to an information processing system associated with the vendor with whom the user wishes to conduct the transaction; and code for receiving at the accounting system settlement information from the information processing system associated with the vendor once the transaction between the vendor and the user has been settled, so that an account information of the user managed by the accounting system can be updated.

In yet another embodiment, a computer readable medium includes code for receiving identification information from a settlement device of a user who wishes to conduct a transaction with a vendor; code for generating a preauthorization request using the identification information; code for transmitting to a remote accounting system the preauthorization request for the transaction to be conducted between the user and the vendor; code for receiving a reply from the accounting system in response to the preauthorization request; code for storing the received reply in a visitor database associated with the vendor; code for accessing the reply stored in the visitor database to settle the transaction once a transaction amount has determined; and code for transmitting settlement information to the accounting information to enable the accounting system to update accounting information of the user.

### BRIEF DESCRIPTION OF THE DRAWINGS

FIG. 1 is a block diagram illustrating an example of a network connection configuration of an information processing system, which is used for realizing an vendor account settlement system according to an embodiment of the present invention;

FIG. 2 is an exemplary block diagram illustrating an accounting system in a financial institution shown in FIG. 1, a hardware configuration of a communication device, and a software configuration;

FIG. 3 is an exemplary block diagram illustrating a hardware configuration of an information processing unit installed in a retail store A or a retail store B shown in FIG. 1, and a software configuration;

FIG. 4 is a flowchart illustrating processing performed when a user visits a store according to an embodiment of the present invention;

FIG. 5 is a flowchart illustrating processing performed when a user makes a payment according to an embodiment of the present invention;

FIG. 6 is a flowchart illustrating settlement processing according to an embodiment of the present invention;

FIG. 7 is a flowchart illustrating amount fixation canceling processing according to an embodiment of the present invention;

FIG. 8 is a flowchart illustrating cash dispensing processing through an ATM according to an embodiment of the present invention;

FIG. 9 is a flowchart illustrating update processing of an allowable limit of purchase after cash is dispensed through an ATM according to an embodiment of the present invention;

FIG. 10 is a diagram illustrating an example of arrangement of components in a retail store B shown in FIG. 1;

FIG. 11 is a chart illustrating a database structure of visitor information according to an embodiment of the present invention;

FIG. 12 is a chart illustrating a database structure of store attribute information according to an embodiment of the present invention;

FIG. 13 is a chart illustrating a database structure of deposit information according to an embodiment of the present invention;

FIG. 14 is a chart illustrating a database structure of personal authentication information according to an embodiment of the present invention;

FIG. 15 is a chart illustrating interrelationships of account amount fixation canceling processing according to an embodiment of the present invention;

FIG. 16 is a chart illustrating interrelationships of account amount fixation canceling processing according to an embodiment of the present invention; and

FIG. 17 is a chart illustrating a database structure of visitor information according to an embodiment of the present invention.

### DETAILED DESCRIPTION OF THE INVENTION

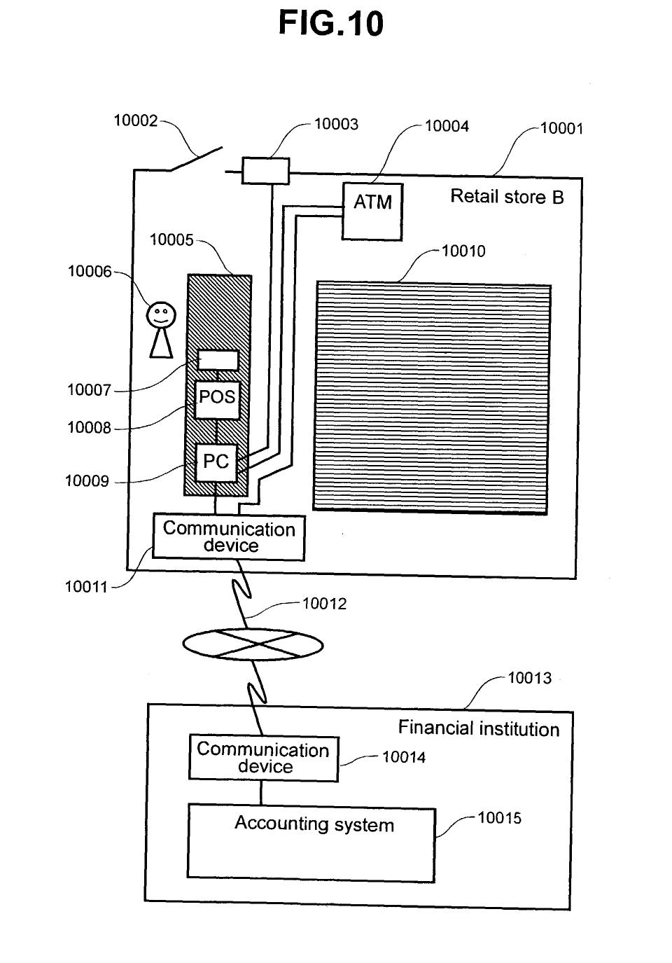

As shown in FIG. 10, when a user visits a retail store B 10001, such as a convenience store, the user brings a settlement card close to a first card detector or reader 10003 installed at a place in close proximity to an entrance 10002. The detector 10003 retrieves identification (ID) information from the settlement card, and then transmits the ID information to an information processing unit 10009, like a personal computer (PC) or server. The detector and the card may be configured to transmit and receive the ID information via a physical communication medium or without physical connection, e.g., wireless transmission. The information processing unit 10009 transmits the ID information to an accounting system 10015 provided at a remote location 10013 controlled by a financial institution. The accounting system 10015 authenticates the ID information, and thereupon sends account information such as an upper limit of settlement amount to the information processing unit 10009 in the store. This authentication process may be completed while the user looks for goods to purchase. After that, at the time of the purchase, a cashier of the retail store B 10001 calculates the total amount of items purchased by the user using a POS (Point of Sales) 10008 of the cash register, and then the user initiates the purchase settlement, e.g., by bringing the settlement card close to a second card detector 10007.

As a result, the detector 10007 retrieves the ID information from the card and transmits it with the total purchase amount to the information processing unit 10009 provided in the store. The information processing unit 10009 compares the upper limit of settlement amount that was previously received from the accounting system 10015 via the preauthorization process described above with the total purchase amount, and then transmits the result of the comparison, i.e., approval or denial of the settlement, to the POS 10008. The POS 10008 displays the result received from the information processing unit on a display before a series of settlement processing is completed. Accordingly, the user is not required to input a password to purchase the goods at the cash register.

As used herein, the “settlement card” refers to a portable device that enables its holder to settle a monetary obligation arising from purchase of goods, receipt of services, or the like by transferring a certain amount of money electronically from the card holder's account to the vendor's account. In one embodiment, such a settlement card includes a debit, credit, or cash card that has a non-volatile memory, e.g., magnetic tape or integrated chip, to store therein information associated with the card. The settlement card or settlement device also include objects that do not have traditional card-like shape, e.g., a cell phone or other portable electronic devices, that may be used to settle a monetary obligation by initiating transfer of a fund from an account of the vendee to an account of the vendor. The terms “settlement card” and “settlement device” are used interchangeably herein.

As used herein, the “detector” refers to a device that is provided at or near a vendor site that receives, reads, or retrieves information associated with the settlement card and communicates with a remote system to initiate pre-authorization or authentication for possible purchase of goods or services by the user (holder of the card). The terms “retrieve,” “read,” and “receive” are used interchangeably herein.

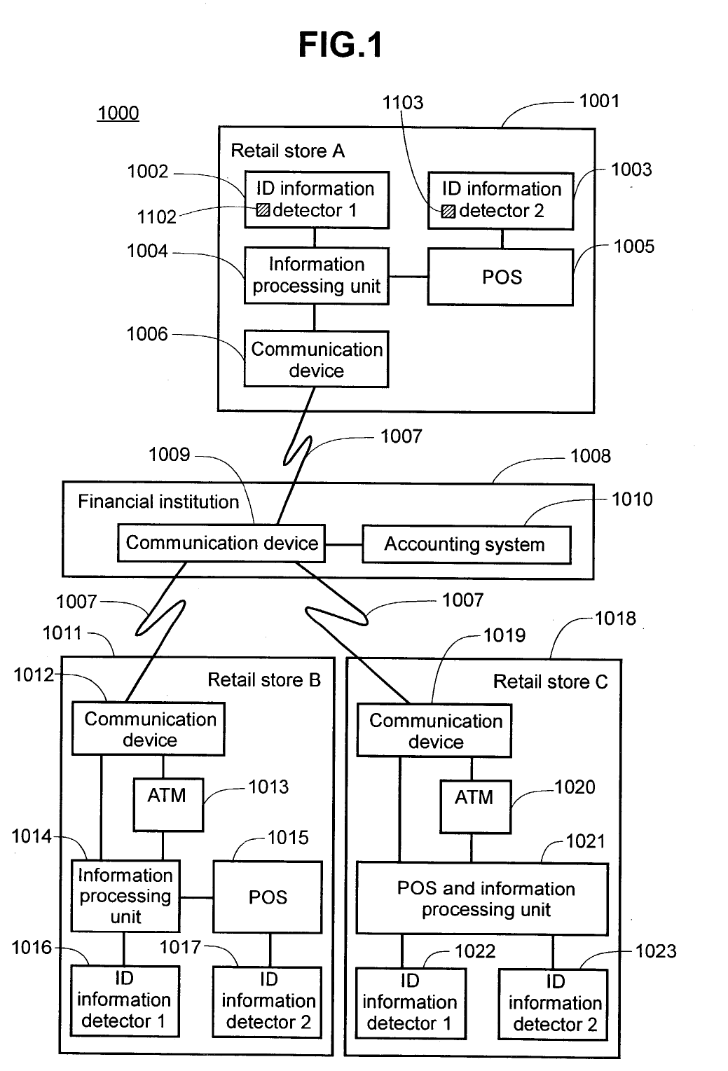

FIG. 1 is a block diagram illustrating an electronic account settlement system 1000 according to one embodiment of the present invention. As shown in the figure, it is so devised that various kinds of vendor account settlement systems 1001, 1011, and 1018, which are installed in retail stores A, B, and C, respectively, are connected to a remote accounting system 1010 of a financial institution 1008, e.g., a bank or credit card company, via a communication network 1007. More specifically, each of the vendor account settlement systems 1001, 1011, and 1018 is connected to the accounting system 1010 via a communication device 1009 of the financial institution 1008.

The accounting system 1010 of the financial institution 1008 is an information processing system, which is realized using a computer system. As described below, the accounting system 1010 has a database, which stores account information including an account number, and account balance for each user as well as security information, e.g., a password. The communication device 1009 of the financial institution 1008 is a well-known device.

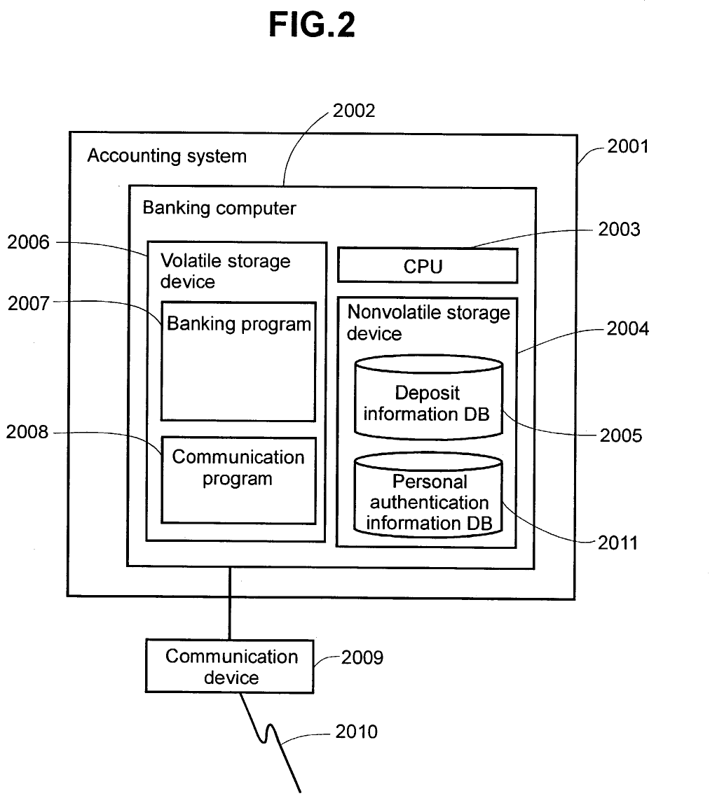

An accounting system 2001 (corresponding to the accounting system 1010), as shown in FIG. 2, includes a banking computer 2002, to which a communication device 2009 (corresponding to the communication device 1009) is connected. The banking computer 2002 comprises the following: a CPU 2003; a first memory, e.g., volatile storage device 2006, that stores a banking program 2007 and a communication program 2008; and a second memory, e.g., nonvolatile storage device 2004, that stores databases including a deposit information DB 2005 and a personal authentication information DB 2011.

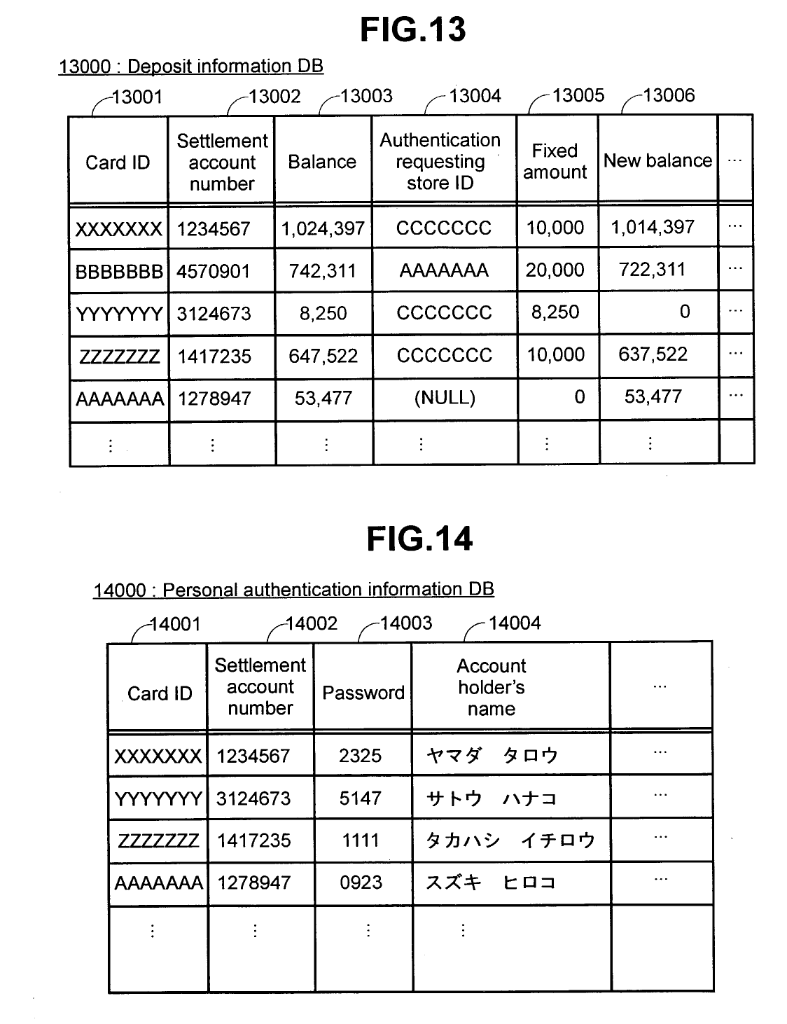

As shown in FIG. 13, the deposit information DB 13000 is a database which includes the following deposit information for each user: a card ID 13001 that identify a settlement card; a settlement account number 13002 associated with the card ID; a balance 13003 of the settlement account; an authentication requesting store ID 13004 described below; a maximum authorized amount 13005 (maximum endorsable amount, preauthorized amount, or fixed amount); and a new balance 13006. As shown in FIG. 14, the personal authentication information DB 14000 is a database which includes the following personal authentication information for each user: a card ID 14001; a settlement account number 14002; a password 14003; and an account holder's name 14004.

Referring back to FIG. 1, configurations of the vendor account settlement systems 1001, 1011, and 1018 will be described. The vendor account settlement system 1001 comprises the following: a first detector (a means for reading identification information used for visiting a store) 1002; a second detector (a means for reading identification information used for settlement) 1003; information processing unit (a user identification information notifying means, a means for receiving data on an upper limit of settlement amount, a means for storing data on an upper limit of settlement amount, and a means for judging whether or not settlement is allowed) 1004; a point-of-sales device (a settlement means, POS) 1005; and a communication device (a communication means) 1006.

The first detector 1002 retrieves or receives card ID information (identification information) from a settlement card of a user when the user visits a store. The second detector 1003 detects card ID information from the settlement card when the user settles an account to purchase a commodity. In one embodiment, the settlement card includes a semiconductor chip to store the user's identification information and transmit to the detector without making physical contact, i.e., wirelessly. In another embodiment, the card includes a magnetic tape or other non-volatile memory device that require physical contact to transmit the information to the detector. The detector is configured to retrieve information from the settlement card. The settlement card and the detector are configured using well-known technologies in one embodiment. As described below, the information processing unit 1004 is a general-purpose computer system according to the present embodiment. An application program having a requisite function is installed in the information processing unit 1004.

In addition, the information processing unit 1004 comprises a storage device having a database for storing requisite information. The point-of-sales device 1005 is a well-known point-of-sales system according to one embodiment. The communication device 1006 is configured by a well-known modem, and the like, and communicates with the communication device 1009 of the financial institution 1008.

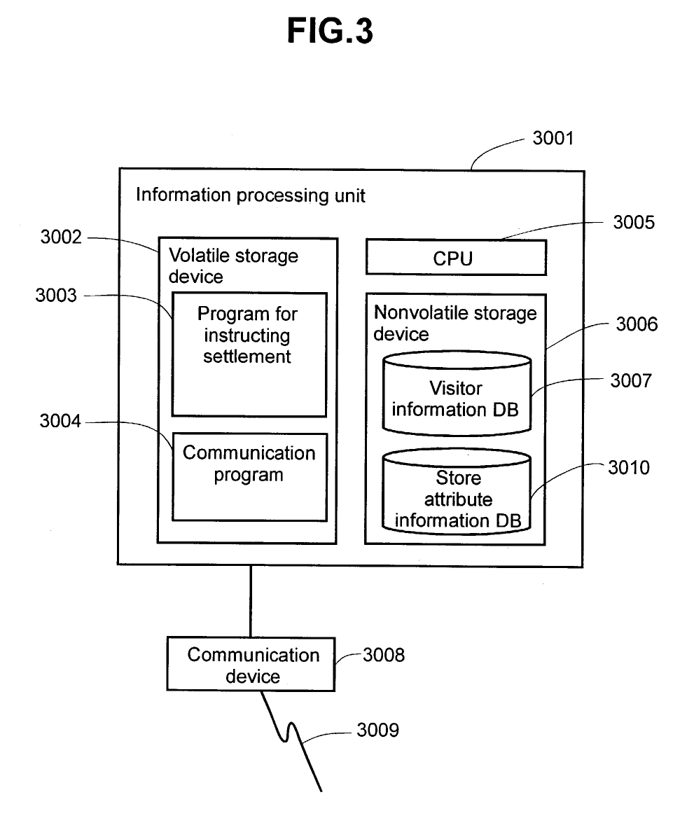

FIG. 3 illustrates an information processing unit 3001 (corresponding to the unit 1004) that is coupled to a communication device 3008 (corresponding to the device 1006). As shown, the information processing unit 3001 comprises a CPU 3005; a volatile storage device 3002 which stores a program for instructing settlement 3003 and a communication program 3004; and a non-volatile storage device 3006 which stores databases including a visitor information DB 3007 and a store attribute information DB 3010.

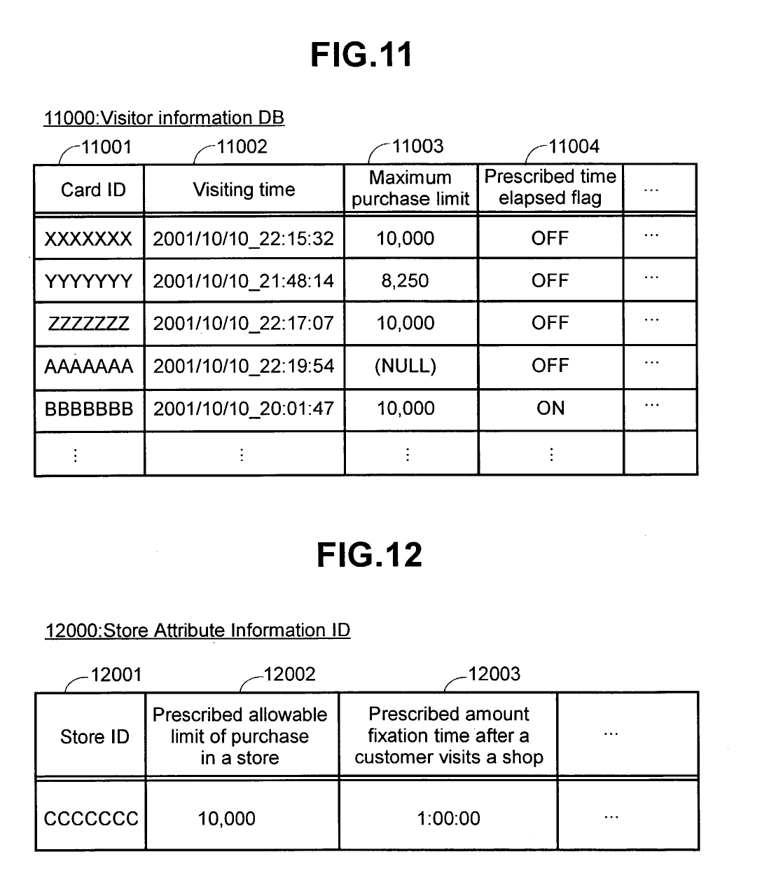

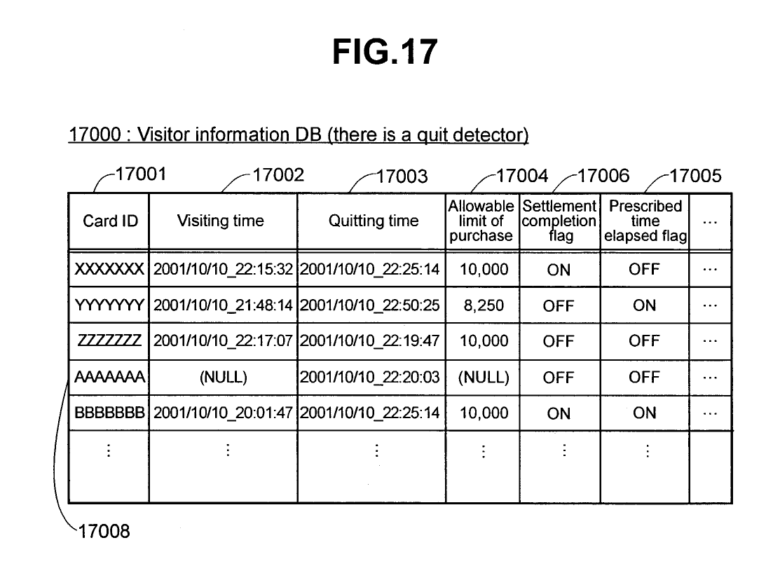

FIG. 11 illustrates a data structure of the visitor information DB 11000 according to one embodiment of the present invention. The visitor information DB 11000 is a database that includes the following information for each visiting customer of the store: a card ID 11001; visiting time 11002; a maximum purchase limit (corresponding to the upper limit of settlement amount) 11003; and a prescribed time elapsed flag 11004 described below. In addition, as shown in FIG. 17, if an end-of-session detector (or a quit detector) which is configured in a manner similar to that of the detector described above is installed, in addition to the information in the database shown in FIG. 11, information such as end-of-session time 17003 (or quitting time) and a settlement completion flag is stored in the visitor information DB 17000. In this case, as described below, if “settlement completion flag” is ON, this indicates that the information processing unit has already transmitted a settlement instruction and an instruction to remove the hold on the maximum authorized amount (or a fixed amount) to the accounting system. Moreover, in FIG. 17, a record 17008 indicates a visiting event of a user having a card ID “AAAAAAA” has not been detected although his or her end-session (or quit event) has been detected.

Further, in another embodiment described later, as shown in FIG. 17, the visitor information DB 17000 includes the following information for each customer visiting the store: a card ID 17001; visiting time 17002; quitting time 17003; a maximum authorized amount (or allowable limit of purchase) 17004; a prescribed time elapsed flag 17005 described later; and a settlement completion flag 17006. As shown in FIG. 12, the store attribute information DB 12000 includes a store ID 12001; a predetermined allowable limit of purchase in a store 12002; and a preauthorization validity duration 12003 that defines how long the preauthorization received from the accounting system remains valid from the visiting time.

As described above with reference to FIG. 1, devices similar to the first detector 1002 including a reader 1102 for reading or receiving card identification information, the second detector 1003 including a reader 1103, the information processing unit 1004, and the communication device 1006, which are installed in the retail store A 1001, are also installed in a retail store B 1011 and a retail store C 1012. As used herein, the term “information processing system” includes the information processing unit 1004 and the communication device 1006. In the case of the retail store B 1011, an automatic teller machine 1013 is connected to a communication device 1012 and an information processing unit 1014 so that data can be transferred. In the case of the retail store C 1012, an automatic teller machine (ATM) is installed in a manner similar to that of the retail store B 1011. Additionally, a POS and an information processing unit are configured as one unit or one system 1021.

Next, operation of the vendor account settlement system having the above-mentioned configuration will be specifically described. Each device and each system operate according to the programs described above. The diagram illustrating a system layout in a store in FIG. 10, and the diagrams illustrating a database structure in FIG. 11 and in FIGS. 14 through 17, which have been described above, can be referred to at any time.

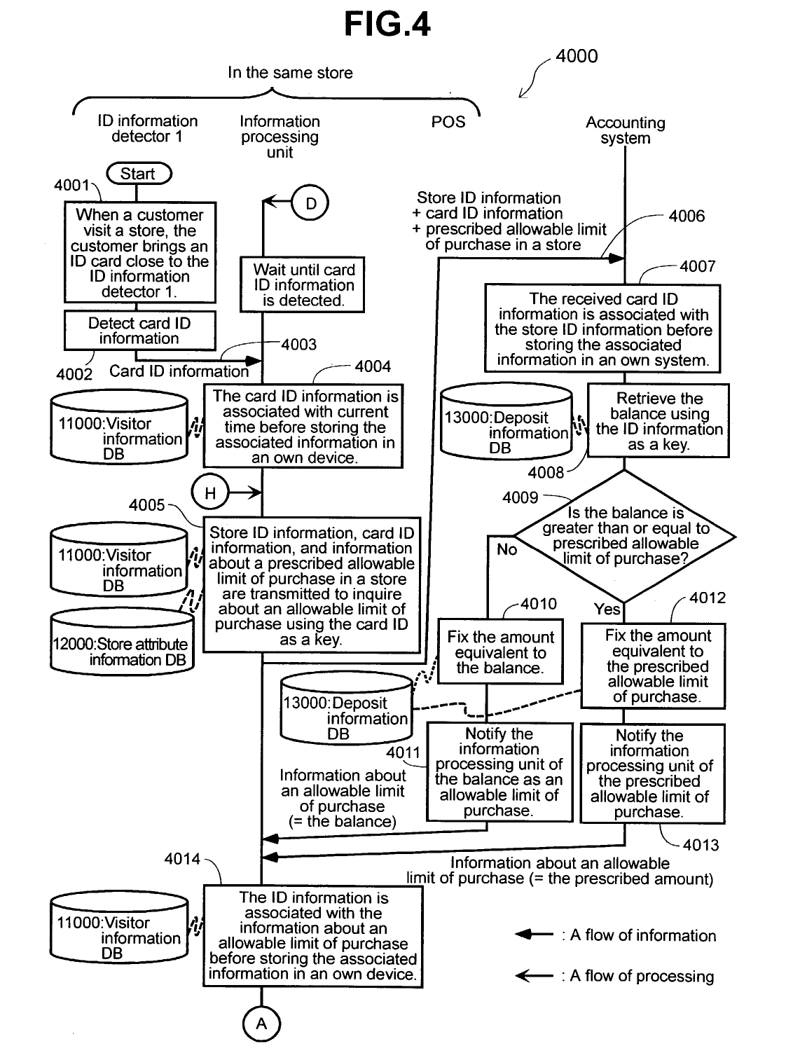

First, operations performed when a user visits a store will be described. As shown in a flowchart or process 4000 of FIG. 4, as soon as a user (customer) brings a settlement card close to a detector 1 placed preferably nearby an entrance of the store (4001), the detector 1 detects the card and retrieves the card ID information (4002) and transmits the card ID information to the information processing unit (4003).

The information processing unit associates the received card ID information with received time (“current time”) before storing the associated information in a visitor information DB 11000 (4004). Next, the card ID information is read from the visitor information DB 11000; and store ID information and information about a prescribed allowable limit of purchase in the store are read from a store attribute information DB 12000. Then, the read information including the store and card ID information is transmitted to an accounting system of an outside financial institution to inquire an allowable limit using the card ID information as a key (4005, 4006). The accounting system of the outside financial institution associates the received card ID information with the store ID information before storing the associated information (4007).

In another embodiment, the card ID information of a user and the store ID information are associated in the information processing unit provided in the store, and the associated information is transmitted to the accounting system as a preauthorization request. As used herein, the term “preauthorization request” or “request” refers to any information that is transmitted by an electronic device associated with a store, vendor or the like to a remote accounting system to initiate authentication or preauthorization for a possible subsequent transaction between the user and the vendor. Accordingly, in one instance, the request includes the store identification information and the card identification information. In another instance, two separate requests are transmitted, one for the card identification information and another for the store identification. In yet another instance, the request information includes the card ID information but not the store ID information.

Referring back to the process 4000, the accounting system accesses a deposit information DB 13000 using the card ID as a key (4008). In this case, if the card ID exists in the deposit information DB 13000, this existence can be used as an authentication. The accounting system also judges whether or not the balance is greater than or equal to a prescribed allowable limit of purchase in a store (4009). If the balance is smaller than the prescribed allowable limit of purchase in a store (4009: NO), the balance is treated as the fixed amount (or maximum endorsable amount) on the deposit information DB 13000 (4010). In this manner, the balance for the fixed amount is temporarily adjusted from the account balance, thereby obtaining a new balance.

In addition, the information processing unit in the store is notified of the balance as an allowable limit of purchase. On the other hand, if the balance is greater than or equal to the prescribed allowable limit of purchase in a store (4009: YES), the prescribed or predetermined allowable limit of purchase in a store is treated as the fixed amount on the deposit information DB 13000 (4012). In this manner, the balance equivalent to the fixed amount is temporarily adjusted from the account and a corresponding hold on the account is placed to preauthorize the fixed amount. In addition, the information processing unit in the store is notified of the balance as an allowable limit of purchase (4013). That is, the accounting system transmits “reply information” to the store in response to the request information. As used herein, the term “reply information” is any information that is transmitted by the accounting system to the store or the like in response to the request information. In one embodiment, the reply information includes an authentication or authorization. In another embodiment, the reply information includes a maximum amount that has been authorized for use in the store, e.g., the fixed amount or maximum endorsable amount.

Once the reply information has been received, the information processing unit associates the notified allowable limit of purchase with the card ID information before storing the associated information in the visitor information DB 11000.

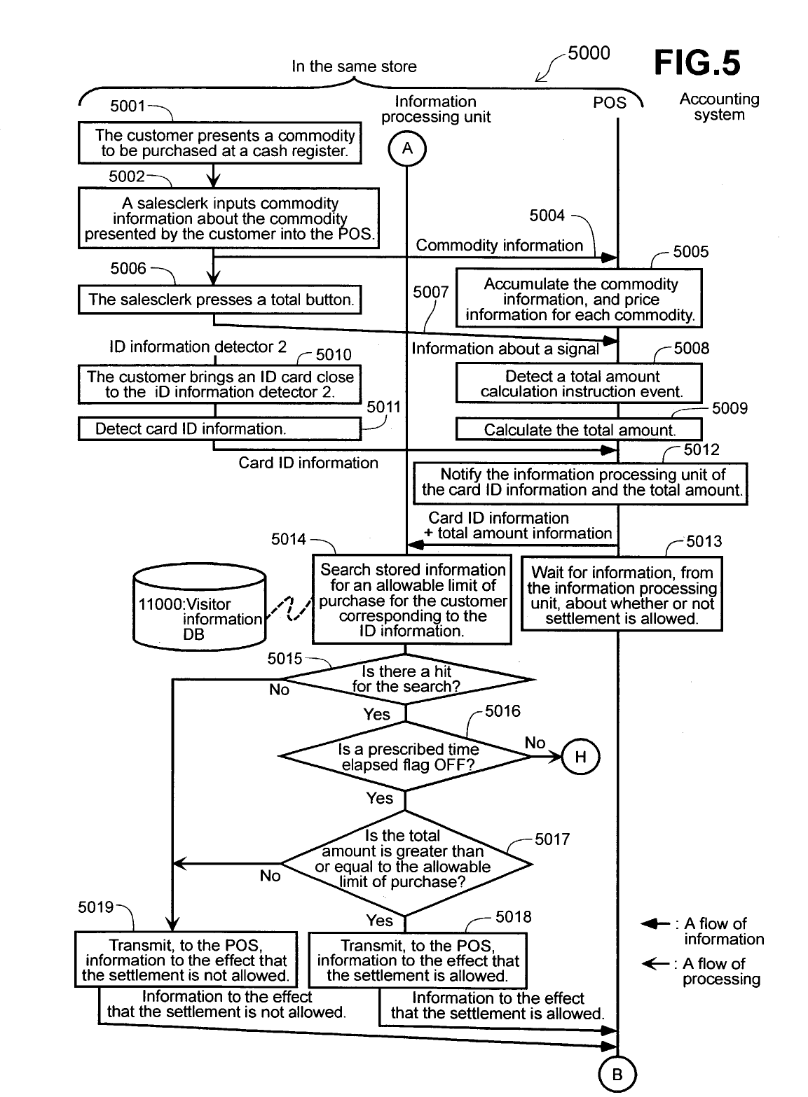

Next, purchase of the goods and settlement thereof using a cash register will be described. As shown in a flowchart or process 5000 of FIG. 5, if the user presents a commodity or item to be purchased at the cash register in the store (5001), a salesclerk inputs information about the commodity into a POS (5002, 5004). Every time commodity information is input, the POS stores the commodity information in association with its price (5005). When the salesclerk presses a total button, the POS calculates the total amount (5006, 5008, 5009). After that, when the user (customer) places a settlement card close to the detector 2 installed near the cash register counter or checkout location (5010), the detector 2 retrieves card ID information (5011), and then transmits the card ID information to the POS. The POS forwards the card ID information and the total amount to the information processing unit (5012) and waits for a notification from the information processing unit as to whether or not settlement is allowed (5013).

On the other hand, the information processing unit, which has received the card ID information and the total amount, searches the visitor information DB 11000 according to the ID information and extracts the allowable limit of purchase which has received from the accounting system when the user entered the store (5014). As a result of the search, if the card ID information does not exist (5015: NO), information to the effect that the settlement is not allowed is transmitted to the POS (5019). If the card ID information exists (5015: YES), the visitor information DB 11000 is checked for a flag that indicates whether or not a predetermined time has elapsed since the user initiated the preauthorization. In one embodiment, the card ID information is deleted from the visitor Information DB automatically rather than using a flag to indicate elapse of the predetermined time.

Referring back to the preauthorization embodiment, if the elapsed time exceeds the prescribed or predetermined time (5016: NO), the process returns to the processing illustrated in the above-mentioned flowchart of FIG. 4. To be more specific, the process proceeds to step H in the figure. Thereafter an inquiry about an allowable limit of purchase is sent to the outside accounting system again using the card information as a key. Meanwhile, the visitor information DB 11000 is checked for a flag that indicates whether or not the time elapsed since the user's visit to the store has exceeded the prescribed time. If the elapsed time has not exceeded the prescribed time (5016: YES), a judgment is made as to whether or not the total amount is smaller than or equal to the allowable limit of purchase (5017). If the total amount exceeds the allowable limit of purchase (5017: NO), information to the effect that the settlement is not allowed is transmitted to the POS (5019). However, if the total amount does not exceed the allowable limit of purchase (5017: YES), information to the effect that the settlement is allowed is transmitted to the POS (5019).

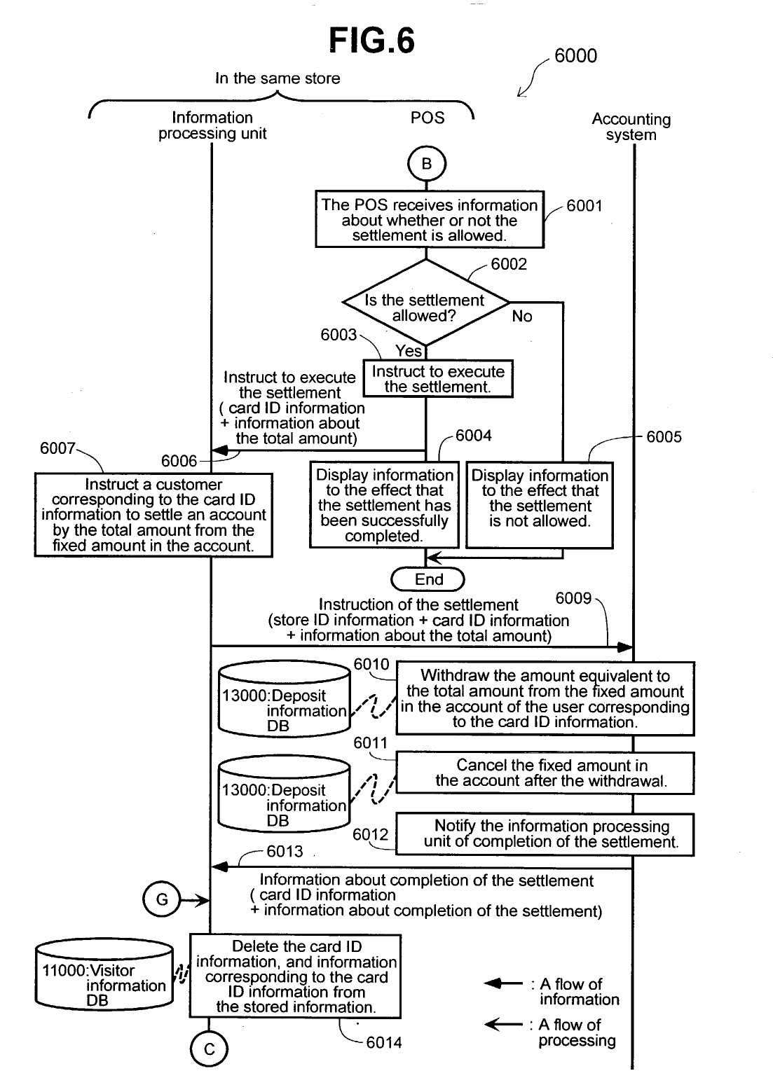

Next, as shown in a flowchart or process 6000 of FIG. 6, the POS receives information about whether or not the settlement is allowed (6001). If the settlement is not allowed (6002: NO), the POS displays information to that effect on its display (6005). On the other hand, if the settlement is allowed (6002: YES), the POS attaches the card ID information and the total amount information to an instruction to execute the settlement before giving the instruction to the information processing unit (6003). Then, the POS indicates that the settlement instruction has been successfully transmitted (6004).

Meanwhile, the information processing unit transmits settlement information to the remote accounting system to debit the total purchase amount to the account corresponding to the card ID information (6009). As used herein, the term “settlement information” refers to any information that is used to initiate the adjustment of the balance of the account according to the purchase settlement. In one embodiment, the settlement information includes the card ID information and the total amount information. In another embodiment, the settlement information includes the store ID information, the card ID information, and the total amount information.

The accounting system updates the deposit information DB 13000 upon receiving the settlement information and subtracts the total purchase amount from the fixed amount in account information of the user corresponding to the card ID information in order to complete the transaction settlement (6010). Next, the accounting system adjusts or updates the balance of the account according to the remaining balance from the fixed amount after the step 6010(6011). Then, the accounting system notifies an information processing unit of the appropriate store of information to the effect that the settlement processing has been completed (6012). At the time of the notification, information about the completion of the settlement including the appropriate card ID information is also attached (6013). The information processing unit of the store, which has received the notification, deletes the card ID information and other related information in the visitor information DB 11000 (6014).

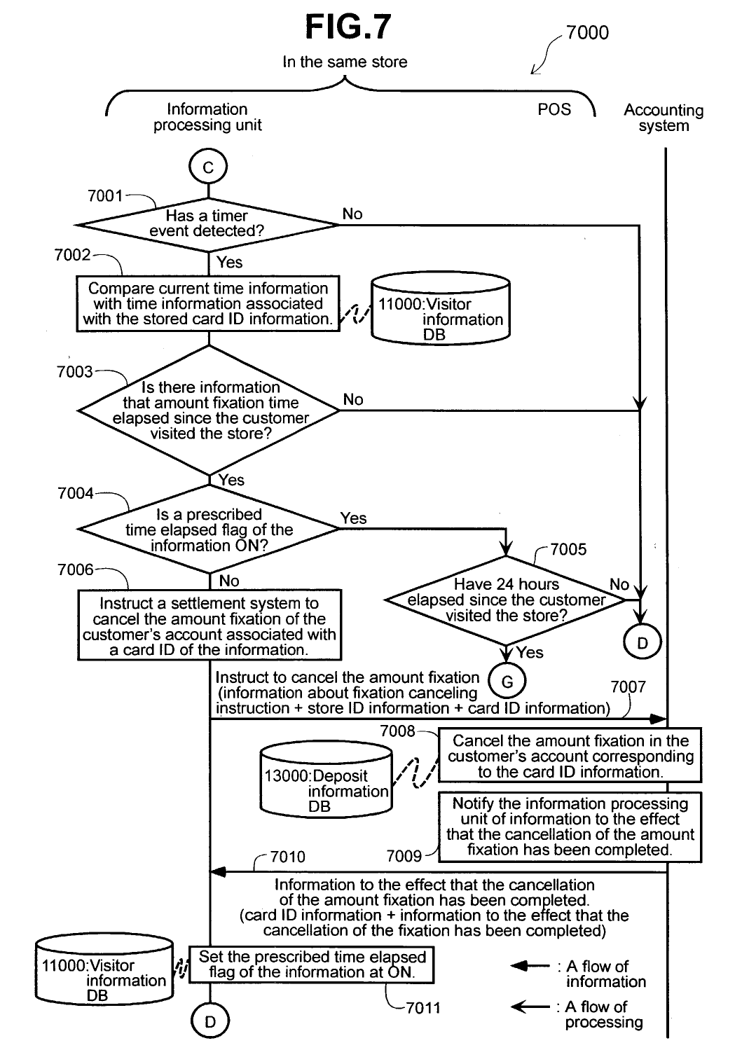

A process 7000 of removal of the hold of the maximum endorsable amount or fixed amount will be described below. The process 7000 is performed after the transaction settlement has been completed or when a user leaves the store without purchasing any goods. As shown in FIG. 7, if the information processing unit in the store detects a timer event that prompts monitoring of visiting time of the user (7001: YES), the information processing unit compares the visiting time with current time obtained from a built-in timer clock. As described above, this visiting time is stored in the visitor information DB 11000 shown in FIG. 11, corresponding to the card ID information. As a result of the comparison of the visiting time with the current time, if the time elapsed since the user visited the store does not exceed the predetermined time or amount fixation time described above (7003: NO), the information processing unit in FIG. 4 enters a state of waiting for detection of card ID information, which is observed when the user visits the store (step “D”). In contrast with this, as a result of the comparison of the visiting time with the current time, if it is judged that the time elapsed since the user visited the store exceeds the amount fixation time described above (7003: YES), a judgment is made as to whether or not a prescribed time elapsed flag (FIG. 11), which has been described in the step of “5016” in FIG. 5, is “ON”. If the prescribed time elapsed flag is ON (7004: YES), and if the time elapsed since the user visited the store is less than 24 hours (7005: NO), the information processing unit is also in a state of waiting for detection of card ID information as shown in FIG. 4 (step “D”). On the other hand, if the time elapsed since the user visited the store is longer than or equal to 24 hours (7005: YES, step “G”), the process returns to the processing in the step “6014” in FIG. 6, where the card ID information and its corresponding information are deleted.

Further, as a result of the comparison of the visiting time with the current time, if it is judged that the time elapsed since the user visited the store exceeds the amount fixation time described above (7003: YES), and if the prescribed time elapsed flag (FIG. 11) is not “ON” (7004: NO), the information processing unit instructs the outside accounting system to cancel the amount fixation of an account corresponding to the card ID information (7006). When transmitting this instruction, in addition to its fixation cancellation instruction information, store ID information and the card ID information are also attached (7007). The accounting system of the financial institution, which has received the information, cancels the amount fixation of the appropriate account, and then updates the deposit information DB 13000 (7008). After that, the accounting system notifies the information processing unit in the store of information to the effect that the cancellation of the amount fixation has been completed. At the time of the notification, the appropriate card ID information is also provided as well (7010). The information processing unit, which has received the notification (information) that the cancellation of the amount fixation has been completed, updates the visitor information DB, and brings a prescribed time elapsed flag corresponding to the appropriate card ID information to the “ON” state. The information processing unit enters a state of waiting for detection of card ID information as shown in FIG. 4 (step “D”).

What will be described next is processing that follows the step A after various steps of the process 4000 have been performed after the user has entered the store (see, FIG. 4). To be more specific, a case where a user performs cashing (withdrawing cash) using ATMs (Automatic Teller Machine) 1013 and 10004 in the retail store B in FIGS. 1 and 10 will be described.

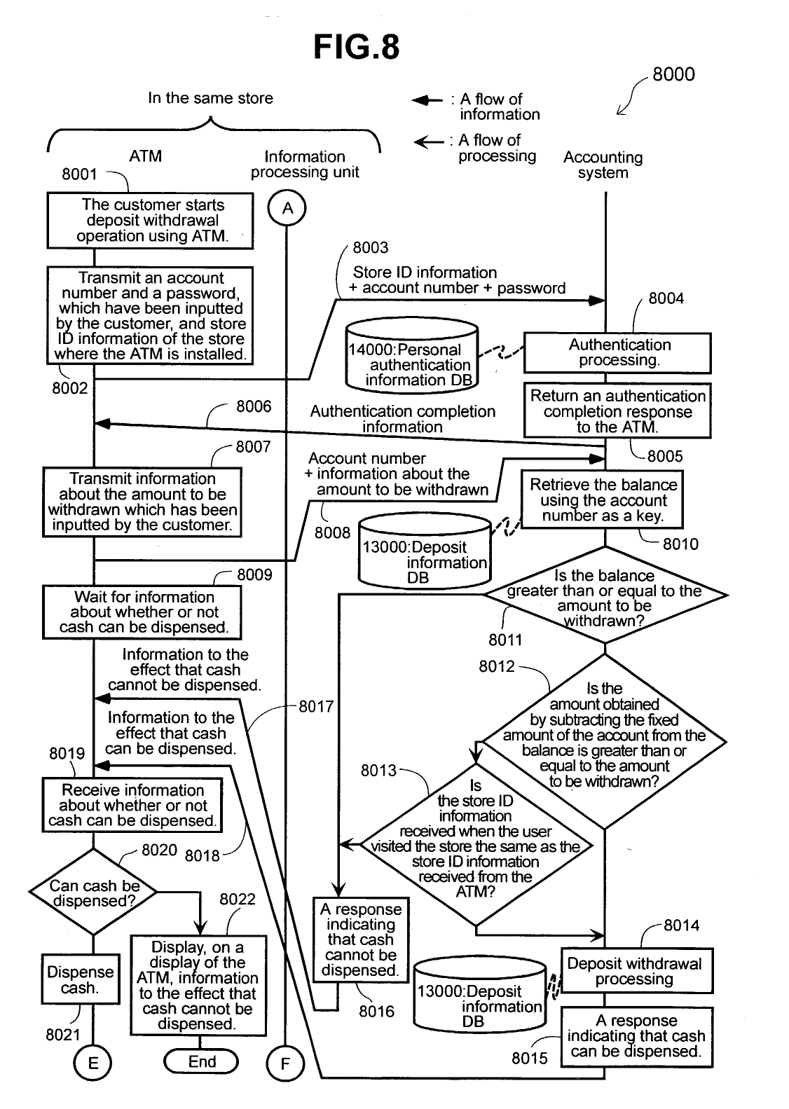

In the first place, as shown in a flowchart or process 8000 of FIG. 8, the user (customer) accesses the ATM (8001). The ATM transmits inputted required information such as an account number, a password, and a store ID to the remote accounting system (8002, 8003). The accounting system, which has received the information, searches the personal authentication information DB to authenticate the transaction, and then sends a response to the ATM (8004, 8005, 8006). The ATM, which has received the response, transmits the amount to be withdrawn inputted by the user to the accounting system together with the account number (8007, 8008). The accounting system, which has received the information, retrieves an appropriate account in the deposit information DB 13000 (8010) using the account number as a key. The accounting system obtains the appropriate account and its balance, judges whether or not the balance of the account is greater than or equal to the request withdrawal amount. If the balance is smaller than the amount to be withdrawn (8011: NO), the accounting system transmits, to the ATM in the store, information to the effect that cash cannot be dispensed (8016, 8017). However, if the balance is greater than or equal to the amount to be withdrawn (8011: YES), the accounting system searches the deposit information DB to check whether or not an adjusted balance after subtracting the fixed amount is greater than or equal to the amount to be withdrawn. If the adjusted amount is smaller than the amount to be withdrawn (8012: NO), whether or not the store ID information received when the user visited the store agrees with the store ID information received from the ATM is checked (8013). If they do not agree (8013: NO), the accounting system transmits, to the ATM in the store, information to the effect that cash cannot be dispensed (8016, 8017). If the amount obtained by the adjustment in the step 8012 is greater than or equal to the amount to be withdrawn (8012: YES), or if both of the store ID information agree in the step 8013 (8013: YES), the deposit information DB is updated, and deposit withdrawal processing is executed. Then, information to the effect that cash can be dispensed is transmitted to the ATM (8014, 8015).

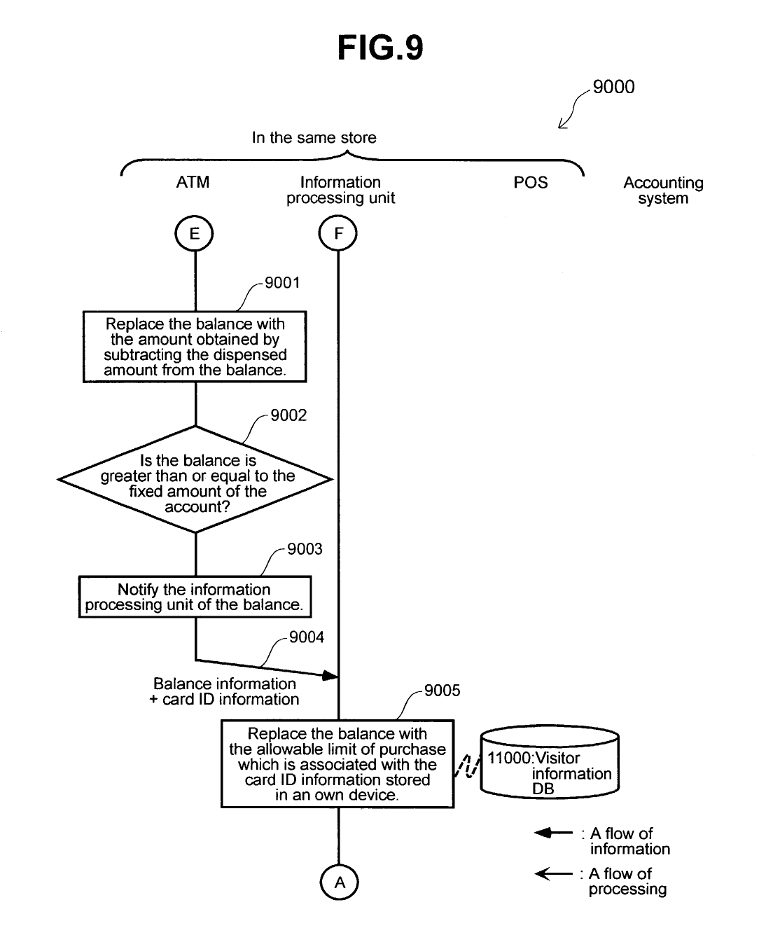

On the other hand, according to the received information about whether or not cash can be dispensed (8019, 8020), the ATM in the store dispenses cash (8021) or displays, on a display that accompanies the ATM, information to the effect that cash cannot be dispensed (8022). Subsequently, as shown in a flowchart 9000 of FIG. 9, the ATM, which has dispensed cash, subtracts the dispensed amount from the balance to determine the new balance, and then checks whether or not the new balance is greater than or equal to the fixed amount of the account before notifying the information processing unit of the new balance (9001, 9002, 9003). At the time of the notification, the information processing unit is also notified of the appropriate card ID information together (9004). On the basis of the new balance and the card ID information that have been received, the information processing unit updates the visitor information DB, and then replaces the appropriate allowable limit of purchase with the new balance (9005).

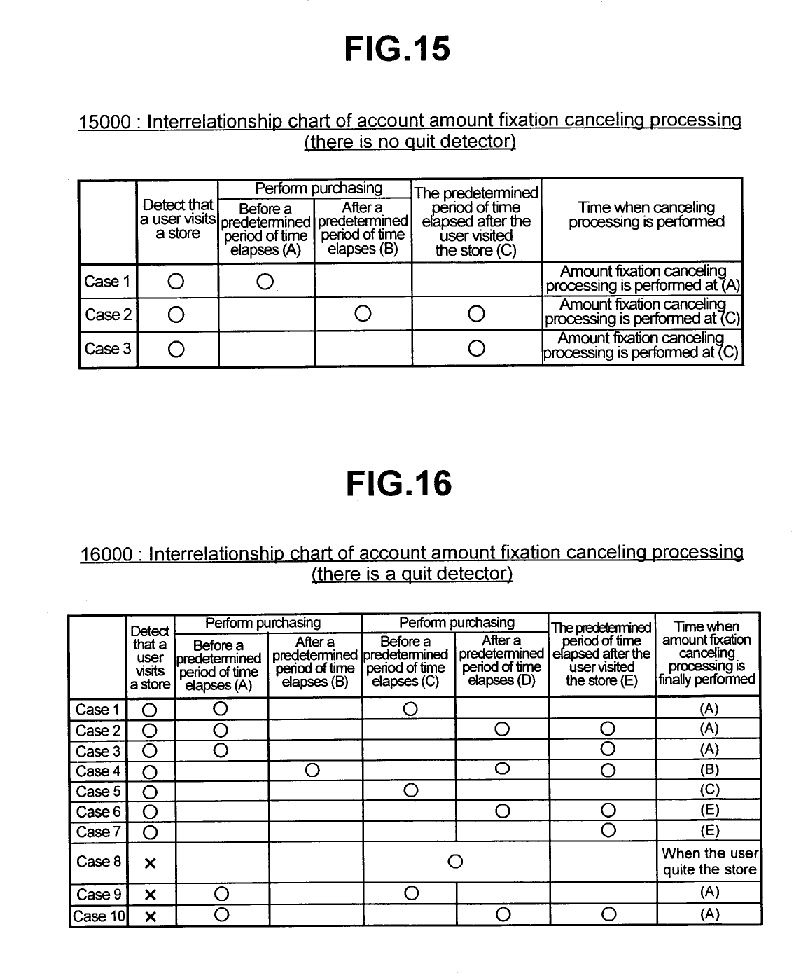

Here, the above-mentioned amount fixation canceling processing will be specifically described taking various assumed cases into consideration. If they are roughly classified, there are the above-mentioned case where the end-of-session detector, which is configured in a manner similar to the detector, is installed and a case where the end-of-session or quit detector is not installed. Both of the cases will be described below. In the first place, the case where the quit detector is not installed will be described. As shown in FIG. 15, if after visiting a store, a user purchases a commodity before a prescribed period of time has elapsed and leaves the store before the prescribed period of time has elapsed (case 1), an amount-fixation-canceling processing is executed at the time of purchase of the commodity (at the time of settlement). In addition, if after visiting a store, a user stays at the store for a long time before purchasing a commodity, i.e., after the prescribed period of time has elapsed (case 2), at the time of purchase of the commodity, a POS sends an inquiry to an information processing unit about the fixed amount to compare the fixed amount with the total amount of the purchasing. The information processing unit accesses the visitor information DB and determines that the prescribed period of time has already elapsed. Therefore, the information processing unit requests the remote accounting system to fix the amount again, and waits for a response. Next, after receiving the response, the information processing unit compares the total purchased amount and the fixed amount. If the total purchased amount is smaller than or equal to the fixed amount, the transaction is settled. Thereafter, the amount fixation canceling process is initiated, i.e., the amount fixation canceling process is initiated with the purchase of a commodity. However, if a user leaves the store without purchasing any item (case 3), the amount fixation canceling process is initiated automatically after the prescribed time has elapsed.

Referring to FIG. 16, the use of a quit detector in a transaction settlement method will be described for exemplary cases 1 to 10. The case 1 involves a situation where a user purchases a commodity and leaves the store before a prescribed period of time is expired (the quit detector detects a quit event). In this case, the amount fixation canceling process is executed at the time of the purchase of a commodity. The case 2 involves a situation where a user purchases a commodity within the prescribed period of time and remains in the store, and then leaves the store after the prescribed period of time has elapsed (the quit detector detects a quit event). In this case, the amount fixation canceling process is initiated at the time of the purchase of a commodity. The case 3 involves a situation where a user purchases a commodity with the prescribed period, but the quit detector failed to detect a quit event before the prescribed period has elapsed although the customer has already left the store. In this case, the amount fixation canceling process is initiated at the time of the purchase of a commodity.

The case 4 involves a situation where a user purchases a commodity after the prescribed period of time has elapsed and leaves the store after the purchase (the quit detector detects a quit event). In this case, as processing at the time of the purchase of the commodity, a POS sends an inquiry to an information processing unit about the fixed amount to try comparison of the fixed amount with the total amount of the purchasing. The information processing unit checks the visitor information DB. As a result, the information processing unit finds out that the prescribed time has already elapsed. Therefore, the information processing unit instructs the accounting system to fix the amount again, and waits for a response of the amount after the fixation is completed. After receiving the response, the information processing unit tries to compare the total amount of the purchasing with the fixed amount. If the total amount of the purchasing is smaller than or equal to the fixed amount, the purchase is permissible, and the amount fixation canceling processing is executed. At the time of the purchase of the commodity, the amount fixation canceling process is carried out.

The case 5 involves a situation where a user does not purchase anything and leaves the store before a prescribed period of time has elapsed (the quit detector detects a quit event). When the quit detector detects the quit event, the amount fixation canceling process or hold canceling process is executed. The case 6 involves a situation where a user does not purchase any commodity and leaves the store after the prescribed period of time has elapsed (the quit detector detects a quit event). When the prescribed time has elapsed, the amount fixation canceling process is executed. The case 7 involves a situation where a user quits the store without purchasing any commodity and a quit event has not been detected. When a prescribed period of time has elapsed since the user visited the store, the amount fixation canceling process is executed. The case 8 involves a situation where a user leaves the store without purchasing any commodity and a visiting event has not been detected (the quit detector detects only a quit event). When the quit detector detects the quit event, the amount fixation canceling process is executed.

The case 9 involves a situation where although a user visits a store, a visiting event has not been detected, and after visiting the store, the user purchases a commodity and leaves the store before a prescribed period of time elapses (the quit detector detects a quit event). In this case, the time when the user has purchased the commodity is treated as a starting point. At the time when the user has purchased the commodity, the amount fixation canceling process is executed. To be more specific, as processing at the time of the purchase of the commodity, the POS inquires the information processing unit for the fixed amount attempts to compare the fixed amount with the total purchase amount. The information processing unit checks information in the visitor information DB. As a result, the information does not exist. Therefore, the information processing unit instructs the accounting system to fix the amount of a customer account corresponding to the ID, and waits for a response of the amount after the fixation is completed. After receiving the response, the information processing unit attempts to compare the total amount of the purchasing with the fixed amount. If the total amount of the purchasing is smaller than or equal to the fixed amount, the purchasing holds. At this point of time, the amount fixation canceling process is executed. To be more specific, at the time of the purchase of the commodity, the amount fixation canceling process is executed.

The case 10 involves a situation where although a user visits a store, a visiting event is not detected, and the user purchases a commodity and then remains in the store until after the prescribed period of time has elapsed (the quit detector detects a quit event). In this case, the time when the user has purchased the commodity is treated as a starting point. To be more specific, at the time of the purchasing, the amount fixation canceling process is executed. To be more specific, as processing at the time of the purchase of the commodity, the POS sends an inquiry to the information processing unit about the fixed amount to try comparison of the fixed amount with the total amount of the purchasing. The information processing unit checks the visitor information DB and does not find the appropriate information. Therefore, the information processing unit instructs the outside accounting system to fix the amount of a customer account corresponding to the ID, and waits for a response of the amount after the fixation is completed. After receiving the response, the information processing unit attempts to compare the total amount of the purchasing with the fixed amount. If the total purchase amount is smaller than or equal to the fixed amount, the purchase is permissible, and the amount fixation canceling process is executed at the time of the purchase of the commodity.

In another embodiment, a method of settling a transaction without inputting a user password at the time of purchase includes the following steps: a debit card terminal is installed beforehand at an entrance of a store; when a user who holds a debit card visits the store, the user uses the debit card terminal to provide account identification information written in the debit card and a password thereof. In this embodiment, if authentication is validated, the user is authorized purchase a product or service for a given period of time without need to input any password. In addition, the user is not required to set an allowable limit of purchase.

In yet another embodiment, a method of settling a transaction electronically involves the steps described below.

When a user having a cellular phone (including PHS) visits a store, the user transmits account identification information and a password to a settlement system using the cellular phone to obtain pre-authorization prior to purchasing the commodity. An antenna for transmitting to and receiving from the cellular phone is installed in the store beforehand. The account identification information and the password are transmitted to the settlement system side together with identification information of the store visited by the user. The user waits for a response from the settlement system side. Once authentication has been successfully completed on the settlement system side, the settlement system transmits an authentication permission code to the cellular phone of the store user. This authentication permission code makes authentication effective within a definite period of time, where the time when the user is authenticated is treated as a starting point. In addition, account balance information of the user, authentication permission code, and information about the term of validity (time) of authentication are transmitted to the store side. The user presents the authentication permission code, which has been transmitted to the user's own cellular phone, to a salesclerk at a cash register at the time of the settlement so that the salesclerk uses a system on the store side to read the authentication permission code. The system on the store side compares the authentication permission code, which has already been received from the settlement system, with the balance information. If the authentication permission code exists in the system on the store side, and if the amount of the purchase is within the balance information associated with the authentication permission code, and if the purchase is within the term of validity (time) of authentication, the settlement is completed. According to this embodiment, the user can do shopping without being restricted by an allowable limit of purchase during the definite period of time. In addition, the user is not required to set an allowable limit of purchase.

As described above, a program for realizing the operation, and the functions, of the information processing unit and the accounting system, which have been described above, is installed in the information processing unit (computer) using a proper transportable recording medium such as a floppy disk, a compact disk, a DVD (Digital Versatile Disc), and a stick type semiconductor memory, or is delivered via a network.

Here, a recording medium used for identification information includes not only a card that is called the debit card (settlement card) by which a cash card of a bank can be utilized as a credit card (the debit card was described in this embodiment), but also a means for recording identification information which enables cashless real-time settlement including a credit card.

According to this embodiment, the following effects are produced. No communication processing for inquiry is required; more specifically, the outside accounting system (host) side is not required to receive an inquiry about authentication and an inquiry about an allowable limit of purchase. Therefore, vendor account settlement processing can be completed securely and quickly without causing a long line to form at a cash register.

In addition, it is also possible to eliminate a troublesome labor of setting an allowable limit of cashless purchase beforehand for each item that a user purchases. Moreover, it is possible to secure the amount required for the settlement of the purchase in a store by fixing the predetermined amount from the balance of an account of a financial institution while a user visit the store. Accordingly, at the time of payment for a charge in a store, a labor of inputting a user password can be eliminated. Additionally, the user is not required to set an allowable limit of purchase beforehand.

The above detailed descriptions are provided to illustrate specific embodiments of the present invention and are not intended to be limiting. Numerous modifications and variations within the scope of the present invention are possible. Accordingly, the present invention is defined by the appended claims.

What is claimed is:

1. An electronic account settlement system, comprising:
a preauthorization device provided at a vendor site and having a first receiver to receive first identification information of a user, the preauthorization device being configured to initiate a preauthorization request for a subsequent transaction of a product or service between the user and a vendor of the vendor site; and
an accounting system provided at a remote location from the preauthorization device, the accounting system having a database including account information relating to a plurality of users and being configured to receive the preauthorization request and decide whether to grant or reject the preauthorization request using the account information.

2. The electronic account settlement system of claim 1, wherein the preauthorization device receives the first identification information of the user from a settlement card of the user.

3. The electronic account settlement system of claim 2, wherein the settlement card is a debit card, a credit card, or a check card.

4. The electronic account settlement system of claim 2, wherein the preauthorization device receives the first identification information from the settlement card via a physical or wireless communication link between the preauthorization device and the settlement card.

5. The electronic account settlement system of claim 1, wherein the preauthorization device receives the first identification information of the user from a portable electronic device of the user.

6. The electronic account settlement system of claim 1, wherein the accounting system is configured to receive settlement information from an information processing unit associated with the vendor site after the user has purchased the product or received the service.

7. The electronic account settlement system of claim 6, further comprising:
an authorization device provided at the vendor site and having a second receiver to receive second identification information of the user after the user has selected the product to be purchased or the service to be received in order to initiate settlement for the product or service, the second identification information of the user corresponding to the first identification information of the user.

8. The electronic account settlement system of claim 7, wherein the user is not required to input security information to the authorization device to complete the settlement for the product or service.

9. The electronic account settlement system of claim 1, wherein the user is not required to input security information to complete the preauthorization request.

10. The electronic account settlement system of claim 1, wherein the accounting system includes:
a deposit information database including the account information of the plurality of the users, the account information for each user including a maximum endorsable amount that is user and vendor specific, wherein the grant of the preauthorization request is for a settlement of transaction that is no more than the maximum endorsable amount.

11. An electronic accounting system, comprising:
a preauthorization device provided at close proximity of an entrance of a vendor site and including a first receiver to receive first identification information of a user to initiate a preauthorization request prior to purchase of a product from the vendor site;
an accounting system provided at a remote location from the preauthorization device, the accounting system including a database having account information of a plurality of users and being configured to receive the preauthorization request and transmit a reply to the preauthorization request; and
an authorization device provided at a checkout location of the vendor site, the authorization device including a second receiver to receive second identification information from the user in order to pay for a product the user has selected for purchase from the vendor site, the second identification information corresponding to the first identification information.

12. The electronic accounting system of claim 11, wherein the reply to the preauthorization request is transmitted to an information processing unit associated with the vendor site, the information processing unit having a visitor information database wherein the reply is stored.

13. The electronic accounting system of claim 12, wherein the information processing unit is configured to receive the second identification information from the authorization device and access the reply stored in the visitor information database using the second identification information to determine whether or not to authorize the purchase.

14. A method for making a settlement in an accounting system having an account information database, the account information database including account information of a plurality of users, the method comprising:
receiving at the accounting system a preauthorization request for a transaction to be conducted by a user, the preauthorization request being initiated by reading first identification information of the user from a settlement device of the user using an electronic reader that is associated with a vendor with whom the user wishes to conduct the transaction; and
transmitting a reply to the preauthorization request from the accounting system to a visitor database associated with the vendor with whom the user wishes to conduct the transaction.

15. The method of claim 14, wherein the reply stored in the visitor database associated with the vendor is accessed subsequently to settle the transaction between the user and the vendor.

16. The method of claim 14, further comprising:
accessing account information of the user stored in the account information database using information provided in the preauthorization request; and
determining a maximum amount to preauthorize using the accessed account information.

17. The method of claim 16, wherein the reply transmitted to the visitor database includes the maximum amount and user identification information corresponding to the first identification information, where the maximum amount is vendor and user specific.

18. The method of claim 16, wherein the preauthorization request is generated without requiring the user to input security information.

19. The method of claim 18, further comprising:
receiving at the accounting system settlement information from an information processing unit associated with the vendor once the transaction between the vendor and the user has been settled in order to update the account information of the user.

20. The method of claim 14, wherein the settlement device is one selected from the following group: a credit card, a debit card, a check card, a mobile phone, and a portable digital assistant.

21. A computer readable medium, comprising:
code for receiving at an accounting system a preauthorization request for a transaction to be conducted by a user, wherein the preauthorization request is initiated by reading first identification information of the user from a settlement device of the user using an electronic reader that is associated with a vendor with whom the user wishes to conduct the transaction;
code for transmitting a reply to the preauthorization request from the accounting system to an information processing system associated with the vendor with whom the user wishes to conduct the transaction; and
code for receiving at the accounting system settlement information from the information processing system associated with the vendor once the transaction between the vendor and the user has been settled, so that an account information of the user managed by the accounting system can be updated.

22. A computer readable medium, comprising:
code for receiving identification information from a settlement device of a user who wishes to conduct a transaction with a vendor;
code for generating a preauthorization request using the identification information;
code for transmitting to a remote accounting system the preauthorization request for the transaction to be conducted between the user and the vendor;
code for receiving a reply from the accounting system in response to the preauthorization request;
code for storing the received reply in a visitor database associated with the vendor;
code for accessing the reply stored in the visitor database to settle the transaction once a transaction amount has determined; and
code for transmitting settlement information to the accounting information to enable the accounting system to update accounting information of the user.
